(19) United States
(12) Patent Application Publication
(10) Pub. No.: US 2025/0016680 A1
(43) Pub. Date: Jan. 9, 2025

(54) TDLS OPERATION WITH BROADCAST TWT

(71) Applicant: Samsung Electronics Co., Ltd., Suwon-si (KR)

(72) Inventors: Rubayet Shafin, Allen, TX (US); Elliot Jen, Taipei City (TW); Yue Qi, Plano, TX (US); Boon Loong Ng, Plano, TX (US); Peshal Nayak, Plano, TX (US); Vishnu Vardhan Ratnam, Plano, TX (US)

(21) Appl. No.: 18/755,571

(22) Filed: Jun. 26, 2024

Related U.S. Application Data
(60) Provisional application No. 63/525,449, filed on Jul. 7, 2023.
(60) Provisional application No. 63/526,399, filed on Jul. 12, 2023.
(60) Provisional application No. 63/538,262, filed on Sep. 13, 2023.
(60) Provisional application No. 63/542,968, filed on Oct. 6, 2023.

(51) Int. Cl. H04W 52/02; H04W 72/30; H04W 76/14; H04W 76/40; H04W 84/12

(52) U.S. Cl. CPC H04W 52/0235; H04W 72/30; H04W 76/14; H04W 76/40; H04W 84/12

(57) ABSTRACT

A first tunneled direct-link setup (TDLS) peer station (STA) comprises a transceiver configured to transmit and receive signals and a processor operably coupled to the transceiver. The processor is configured to transmit a TDLS broadcast TWT request frame to a second TDLS peer STA. The processor is configured to receive a TDLS broadcast TWT response frame in response to the TDLS broadcast TWT request frame. The processor is configured to transmit one or more frames to the second TDLS peer STA over a TDLS direct link during a target wake time (TWT) service period (SP) corresponding to a broadcast TWT schedule. The first TDLS peer STA is a member of the broadcast TWT schedule.

### CROSS-REFERENCE TO RELATED APPLICATIONS

This application claims the benefit of priority from U.S. Provisional Application No. 63/525,449, entitled “TDLS OPERATION WITH BROADCAST TWT,” filed Jul. 7, 2023; U.S. Provisional Application No. 63/526,399, entitled “TDLS OPERATION WITH BROADCAST TWT,” filed Jul. 12, 2023; U.S. Provisional Application No. 63/538,262, entitled “TDLS OPERATION WITH BROADCAST TWT,” filed Sep. 13, 2023; and U.S. Provisional Application No. 63/542,968, entitled “TDLS OPERATION WITH BROADCAST TWT,” filed Oct. 6, 2023, all of which are incorporated herein by reference in their entirety.

### TECHNICAL FIELD

This disclosure relates generally to a wireless communication system, and more particularly to, for example, but not limited to, a target wake time (TWT) operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the present disclosure provides a first tunneled direct-link setup (TDLS) peer station (STA) in a wireless network. The first TDLS peer STA comprises a transceiver configured to transmit and receive signals and a processor operably coupled to the transceiver. The processor is configured to transmit a TDLS broadcast TWT request frame to a second TDLS peer STA, receive a TDLS broadcast TWT response frame from the second TDLS peer STA in response to the TDLS broadcast TWT request frame, and transmit one or more frames to the second TDLS peer STA over a TDLS direct link during a target wake time (TWT) service period (SP) corresponding to a broadcast TWT schedule, wherein the first TDLS peer STA is a member of the broadcast TWT schedule.

In some embodiments, the broadcast TWT schedule is identified by a broadcast TWT identifier field in a TWT information extension element in the TDLS broadcast TWT request frame.

In some embodiments, the TDLS broadcast TWT response frame includes a status code of SUCCESS.

In some embodiments, a value in a broadcast TWT identifier field in a TWT information extension element in the TDLS broadcast TWT response frame is a same as a value in the broadcast TWT identifier field in the TWT information extension element in the TDLS broadcast TWT request frame.

In some embodiments, the second TDLS peer STA is expected to be in an awake state during the TWT SP corresponding to the broadcast TWT schedule.

In some embodiments, the TDLS broadcast TWT request frame includes a dialog token field that includes a value that is unique among TDLS broadcast TWT request Action fields for which a corresponding TDLS broadcast TWT response action field has not been received.

In some embodiments, the TDLS broadcast TWT response frame includes a dialog token field that is set to a value included in a corresponding TDLS broadcast TWT request action field.

An aspect of the present disclosure provides a first tunneled direct-link setup (TDLS) peer station (STA) in a wireless network. The first TDLS peer STA comprises a transceiver configured to transmit and receive signals and a processor operably coupled to the transceiver. The processor is configured to receive a TDLS broadcast TWT request frame from a second TDLS peer STA, transmit a TDLS broadcast TWT response to the second TDLS peer STA in response to the TDLS broadcast TWT request frame, and receive one or more frames from the second TDLS peer STA over a TDLS direct link during a target wake time (TWT) service period (SP) corresponding to a broadcast TWT schedule, wherein the second TDLS peer STA is a member of the broadcast TWT schedule.

In some embodiments, the broadcast TWT schedule is identified by a broadcast TWT identifier field in a TWT information extension element in the TDLS broadcast TWT request frame.

In some embodiments, the TDLS broadcast TWT response frame includes a status code of SUCCESS.

In some embodiments, a value in a broadcast TWT identifier field in a TWT information extension element in the TDLS broadcast TWT response frame is a same as a value in the broadcast TWT identifier field in the TWT information extension element in the TDLS broadcast TWT request frame.

In some embodiments, the first TDLS peer STA is expected to be in an awake state during the TWT SP corresponding to the broadcast TWT schedule.

In some embodiments, the TDLS broadcast TWT request frame includes a dialog token field that includes a value that is unique among TDLS broadcast TWT request Action fields for which a corresponding TDLS broadcast TWT response action field has not been received by the second TDLS peer STA.

In some embodiments, the TDLS broadcast TWT response frame includes a dialog token field that is set to a value included in a corresponding TDLS broadcast TWT request action field.

An aspect of the present disclosure provides a method operated by a first tunneled direct-link setup (TDLS) peer station (STA) in a wireless network. The method comprises transmitting a TDLS broadcast TWT request frame to a second TDLS peer STA, receiving a TDLS broadcast TWT response frame in response to the TDLS broadcast TWT request frame, and transmitting one or more frames to the second TDLS peer STA over a TDLS direct link during a target wake time (TWT) service period (SP) corresponding to a broadcast TWT schedule, wherein the first TDLS peer STA is a member of the broadcast TWT schedule.

In some embodiments, the broadcast TWT schedule is identified by a broadcast TWT identifier field in a TWT information extension element in the TDLS broadcast TWT request frame.

In some embodiments, the TDLS broadcast TWT response frame includes a status code of SUCCESS.

In some embodiments, a value in a broadcast TWT identifier field in a TWT information extension element in the TDLS broadcast TWT response frame is a same as a value in the broadcast TWT identifier field in the TWT information extension element in the TDLS broadcast TWT request frame.

In some embodiments, the second TDLS peer STA is expected to be in an awake state during the TWT SP corresponding to the broadcast TWT schedule.

In some embodiments, the TDLS broadcast TWT request frame includes a dialog token field that includes a value that is unique among TDLS broadcast TWT request Action fields for which a corresponding TDLS broadcast TWT response action field has not been received

In some embodiments, the TDLS broadcast TWT response frame includes a dialog token field that is set to a value included in a corresponding TDLS broadcast TWT request action field.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIGS. 4A and 4B show an example of a TDLS Discovery process in accordance with an embodiment.

FIGS. 5A and 5B show an example topology for P2P communication in accordance with an embodiment.

FIG. 6 shows an example format of a B-TWT information element in accordance with an embodiment.

FIG. 7 shows another example format of the B-TWT information element in accordance with an embodiment.

FIG. 8 shows an example process of a requester STA in accordance with an embodiment.

FIG. 9 shows an example process of a responder STA in accordance with an embodiment.

FIG. 10 shows an example format of a TWT information extension element in accordance with an embodiment.

FIG. 11 shows an example format of a TWT information extension element in accordance with an embodiment.

FIG. 12 shows an example format of a TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11bc standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

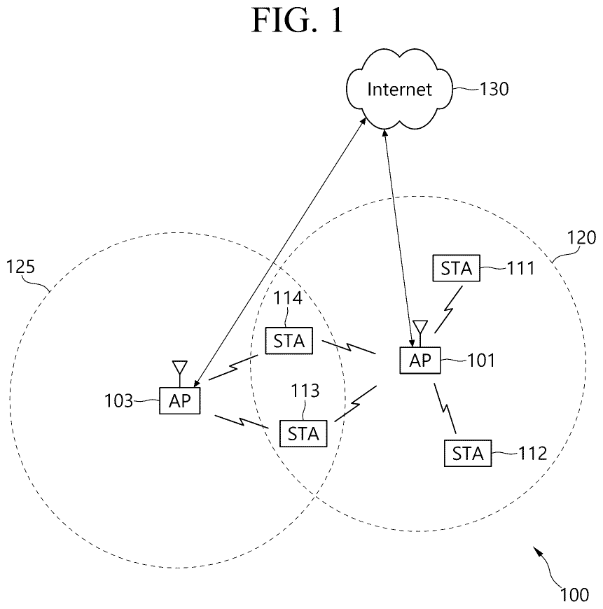

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

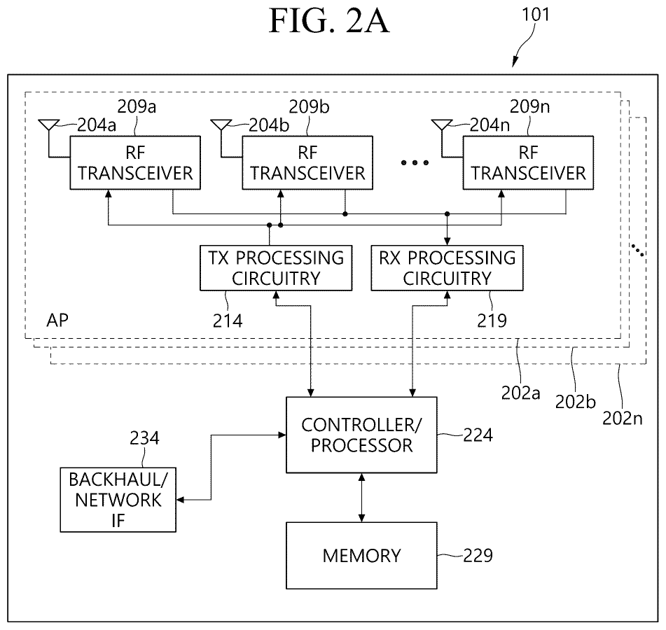

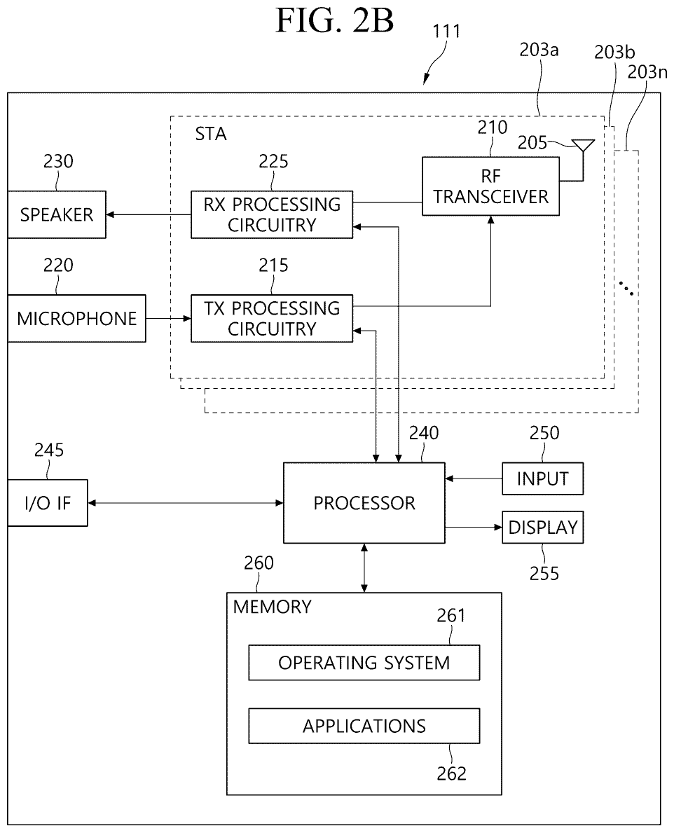

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

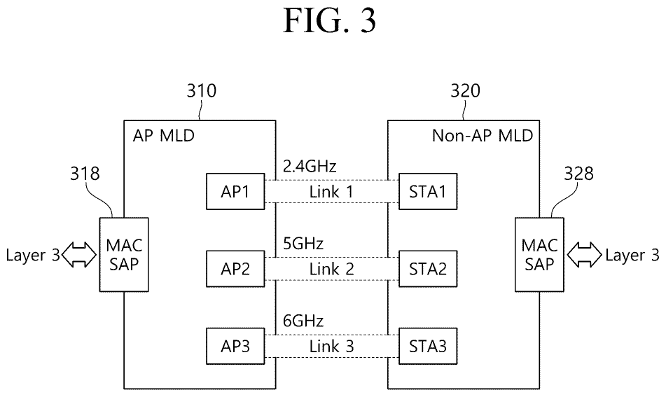

FIG. 3 shows an example of multi-link communication operation in accordance with an embodiment. The multi-link communication operation may be usable in IEEE 802.11bc standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It can be achieved by allocating STAs to operate at non-overlapping times or frequencies and perform the frame exchange sequences in pre-scheduled service periods. In the TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement or TWT schedule, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

TWT enhancements for multi-link devices (MLDs) have been introduced in IEEE 802.11be standard. For individual TWT agreements between two MLDs, a STA affiliated with an MLD, which is a TWT requesting STA, may indicate the links that are requested for setting up TWT agreements in the link ID bitmap subfield of a TWT element in the TWT request. If only one link is indicated in the link ID bitmap subfield of the TWT element, a single TWT agreement is requested for the STA affiliated with the same MLD, which is operating on the indicated link. A target wake time field of the TWT element may be in reference to the timing synchronization function (TSF) of the link indicated by the TWT element. A TWT responding STA affiliated with a peer MLD that receives a TWT request that contains a link ID bitmap subfield in a TWT element responds with a TWT response that indicates the links in the Link ID Bitmap field of the TWT element. The link(s), if present, in the TWT element carried in the TWT response, shall be the same as the link(s) indicated in the TWT element of the soliciting TWT request.

A restricted TWT (R-TWT) operation is another feature introduced in IEEE 802.11be standard to provide a better support for latency sensitive applications. The R-TWT operation offers a protected service period (SP) for its member STAs by sending Quiet elements to other STAs in the BSS that are not a member of the R-TWT schedule. The quiet interval corresponding to the Quiet elements overlaps with the initial portion of a restricted TWT SP. Therefore, it can provide more channel access opportunities for the member STAs of the R-TWT schedule, thereby helping latency sensitive traffic flow.

In this disclosure, various embodiments will disclose a TDLS (tunneled direct link setup) discovery and setup process in the multi-link operation.

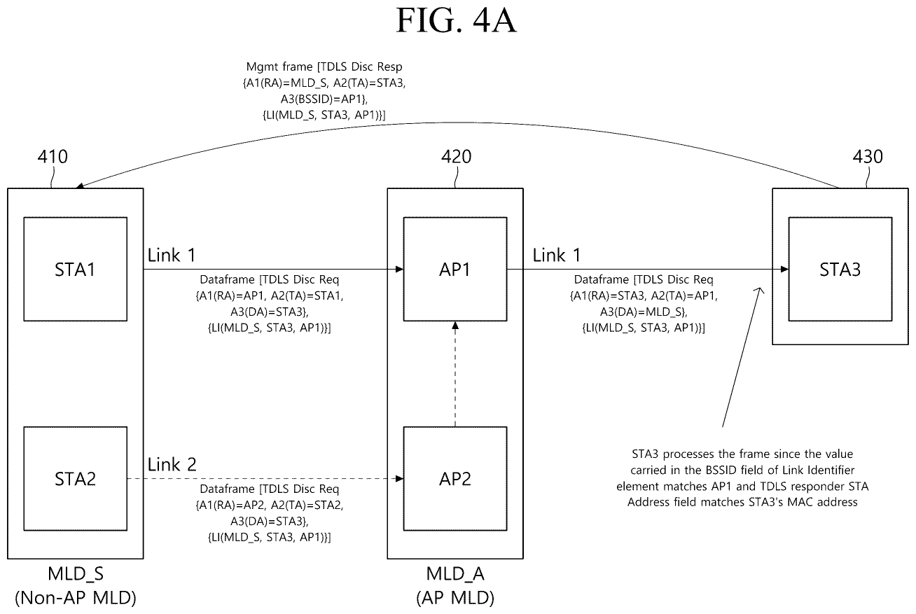

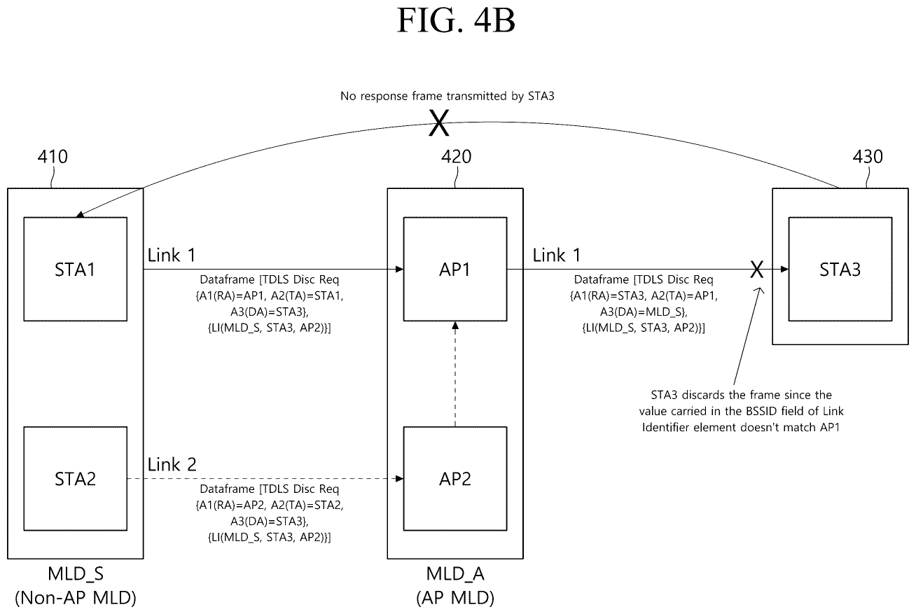

FIGS. 4A and 4B show an example of a TDLS Discovery process in accordance with an embodiment. The TDLS discovery process may be applicable to IEEE 802.11be standard and any future amendments to IEEE 802.11 standard.

In FIGS. 4A and 4B, the TDLS discovery process may be initiated by a non-AP MLD 410. Multiple links (for example, link 1 and link 2) may be set up between the non-AP MLD 410 and an AP MLD 420. The non-AP MLD 410 and the AP MLD 420 may be also referred to as MLD_S and MLD_A, respectively. The non-AP MLD 410 may include a plurality of affiliated STAs, for example STA 1 and STA 2. The AP MLD 420 may include a plurality of APs, for example AP 1 and AP 2. STA 1 and AP 1 may operate on link 1, and STA 2 and AP 2 may operate on link 2. STA 1 is associated with AP 1 and STA 2 is associated with AP 2. Furthermore, STA 3 may be affiliated with a non-MLD 430. Therefore, STA 3 may not be affiliated with an MLD and may not have the capability to perform the multi-link operation. STA 3 may be associated with AP 1 of AP MLD 420.

In this example of FIGS. 4A and 4B, the non-AP MLD 410 may initiate the TDLS discovery process by transmitting two TDLS discovery request frames to the AP MLD 420 because the non-AP MLD 410 is unaware of which link STA 3 is operating on and whether STA 3 is an MLD or a STA not affiliated with an MLD. Those TDLS discovery request frames may be data frames. Each of TDLS discovery request frames may include an address 1 (A1) field, and an address 2 (A2) field, an address 3 (A3) field, and a link identifier element (LI). The A1 field may be a receiver address (RA) field, the A2 field may be a transmitter address (TA) field, and the A3 field may be a destination address (DA) field. The link identifier element may include a TDLS initiator STA address field, a TDLS responder STA address field, and a BSSID (basic service set identifier) field. The TDLS discovery request frame shown in FIG. 4A has the BSSID field set to AP 1, while the TDLS discovery request frame shown in FIG. 4B has the BSSID field set to AP 2.

As shown in FIG. 4A, the TDLS discovery request frame may be transmitted from the non-AP MLD 410 to the AP MLD 420 over either link 1 (represented by a solid line) or over link 2 (represented by a dotted line). When the TDLS discovery request frame is transmitted over link 1, the A1 (RA) field, the A2 (TA) field, and the A 3 (DA) field of the TDLS discovery request frame may be set to AP 1, STA 1, and STA 3, respectively. Additionally, within the link identifier element of the TDLS discovery request frame, the TDLS initiator STA address field, the TDLS responder STA address field, and BSSID field may be set to MLD_S, STA 3, and AP 1, respectively. Similarly, when the TDLS discovery request frame is transmitted over link 2, the A1 (RA) field, the A2 (TA) field, and the A 3 (DA) field of the TDLS discovery request frame may be set to AP 2, STA 2, and STA 3, respectively. Additionally, within the link identifier element within the TDLS discovery request frame, the TDLS initiator STA address field, the TDLS responder STA address field, and the BSSID field may be set to MLD_S, STA 3, and AP 1, respectively. The TDLS discovery request frame may set a To DS (distribution system) subfield of frame control field to 1. The TDLS discovery request frame may be received at the AP MLD 420 by AP 1 or AP 2, and the AP MLD 420 may route the TDLS discovery frame to STA 3 through AP 1 by setting From DS subfield of the frame control field to 1 and A3 (source address, SA) field to MLD_S. In the routed TDLS discovery request frame, the A1 (RA) field, the A2 (TA) field, and the A 3 (SA) field may be set to STA 3, AP 1, and MLD_S, respectively. Additionally, within the link identifier element of the routed TDLS discovery request frame, the TDLS initiator STA address field, the TDLS responder STA address field, and BSSID field may be set to MLD_S, STA 3, and AP 1, respectively. STA 3 may recognize and process the routed TDLS discovery request frame because the value in the BSSID field of the link identifier element matches AP 1 and the TDLS responder STA address field matches a MAC address of STA 3. STA 3 may ignore a TDLS Multi-Link element as it does not recognize the element. STA 3 of the non-MLD 430 may respond with a TDLS discovery response frame, which may be a management frame, with both To DS subfield and From DS subfield set to 0. In the TDLS discovery response frame, the A1 (RA) field is set to MLD_S, the A2 (TA) field is set to STA 3, and the A 3 (BSSID) field is set to AP 1. Additionally, within the link identifier element of the TDLS discovery response frame, the TDLS initiator STA address field, the TDLS responder STA address field, and BSSID field may be set to MLD_S, STA 3, and AP 1, respectively. STA 1, which is a TDLS STA affiliated with the non-AP MLD 410, may receive the TDLS discovery response frame which is sent on the TDLS direct link.

The TDLS discovery request frame in FIG. 4B may be the same as the TDLS discovery request frame in FIG. 4A, with the exception that the BSSID field in the link identifier is set to AP 2. The TDLS discovery request frame may be received at the AP MLD 420 by AP 1 or AP 2, and the AP MLD 420 may route the TDLS discovery frame to STA 3 through AP 1. In the routed TDLS discovery request frame, the BSSID field may be set to AP 2. STA 3 of the non-MLD 430 may discard the routed TDLS discovery request frame because the value in the BSSID field of the link identifier element does not match AP 1. STA 3 may not recognize the BSSID.

When a first STA becomes a member of a first R-TWT schedule and forms a TDLS link with a second STA, there may be a lot of issues related to the operation of R-TWT AND TDLS for the STA. For example, a first R-TWT schedule may allow the STA to perform a P2P communication during an R-TWT SP of the first R-TWT schedule. In this scenario, during the R-TWT SP, the first STA may attempt to transmit a frame to the second STA via the TDLS link. However, the second STA may miss the frame due to some reasons. For instance, the second STA operates in a power save mode, the second STA may be in a doze state when the frame is transmitted by the first STA during the R-TWT SP.

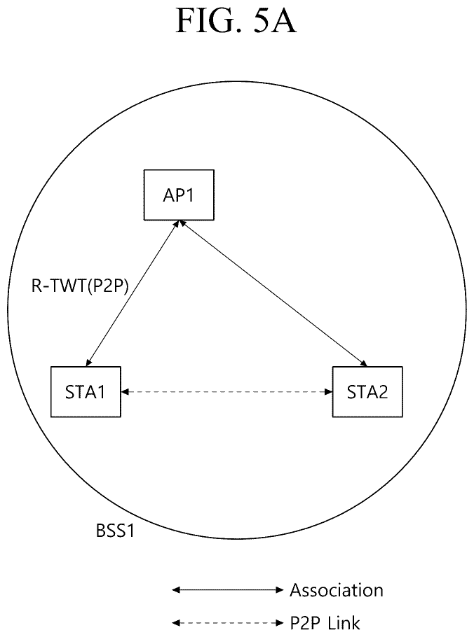

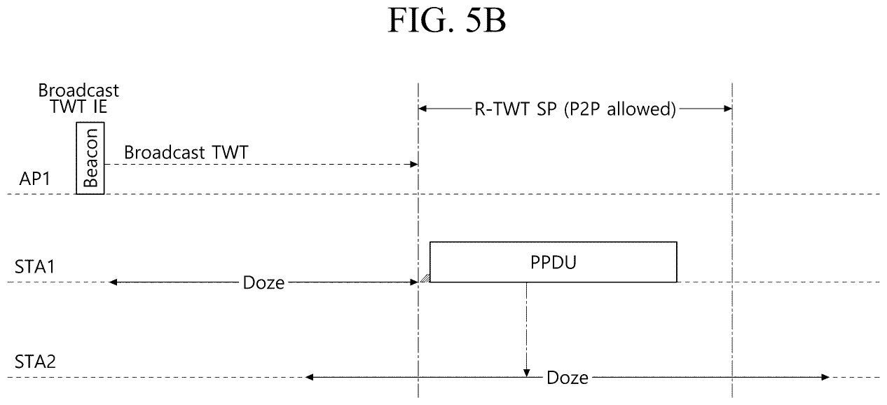

FIGS. 5A and 5B show an example topology for P2P communication in accordance with an embodiment. The examples depicted in FIG. 5 are for illustration purposes and does not limit the scope of this disclosure to any particular implementations.

In FIGS. 5A and 5B, AP 1 has formed BSS 1, in which STA 1 and STA 2 are associated with AP 1. In addition, STA 1 has established a TDLS direct link or a P2P link with STA 2. STA 1 has become a member of an R-TWT schedule advertised by AP 1 which allows P2P communication during the R-TWT SP of the R-TWT schedule. Therefore, during the R-TWT SP, STA 1 may attempt to transmit a frame to STA 2 over the TDLS direct link. However, as discussed above, STA 2 may not be available to receive the frame for some reason. For example, STA 2 may be in a doze state and miss the frame transmitted by STA 1 during the R-TWT SP.

Referring to FIG. 5B, AP 1 sends a beacon frame including a broadcast TWT information element (IE) to establish a broadcast TW schedule with STA 1. The broadcast TWT schedule allows STA 1 to send a frame during the R-TWT SP. As shown, STA 1 sends a PPDU to STA 2 during the R-TWT SP. However, STA 2 misses the PPDU because it is in a doze state when STA 1 transmits the PPDU.

The TWT operation may be also an important feature for TDLS communication. However, the current WLAN system does not provide a mechanism for the operation of the broadcast TWT schedule by TDLS peer STAs for communication over the TDLS direct link.

In this disclosure, a broadcast-TWT (B-TWT) information element is provided to identify a broadcast TWT schedule for TDLS communication.

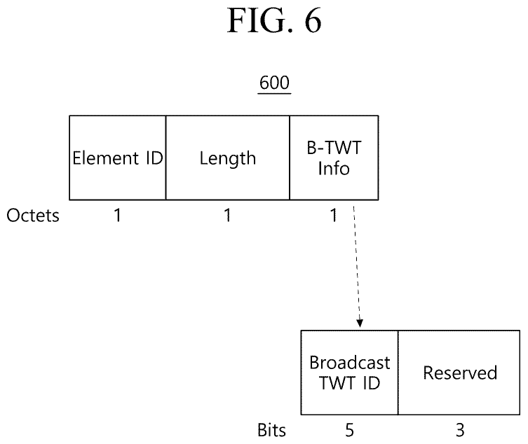

FIG. 6 shows an example format of a B-TWT information element in accordance with an embodiment. The format depicted in FIG. 6 is for illustration purposes and does not limit the scope of this disclosure to any particular implementations.

In FIG. 6, the B-TWT information element 600 includes an Element identifier (ID) field, a Length field, and a B-TWT Info field. The Element ID field may include information to identify the B-TWT information element 600. The Length field may indicate a length of the B-TWT information element 600. The B-TWT Info field may include a Broadcast TWT ID subfield and Reserved bits. The Broadcast TWT ID subfield may include information to identify a broadcast TWT schedule advertised by an AP (e.g., AP 1 in FIGS. 5A and 5B).

In some embodiments, a TDLS Broadcast TWT Request frame and a TDLS Broadcast TWT Response frame may be defined as new TDLS Action fields, as provided Table 1 below.

TABLE 1

| Action field value | Meaning |
|---|---|
| . | . |
| . | . |
| . | . |
| 11 | TDLS Broadcast TWT Request |
| 12 | TDLS Broadcast TWT Response |
| 13-255 | Reserved |

In some embodiments, the TDLS Broadcast TWT Request Action field may include information shown in Table 2 below.

TABLE 2

| Order | Information | Notes |
|---|---|---|
| 1 | Category | The Category field is defined in 9.4.1.11 (Action |
| | | field) |
| 2 | TDLS Action | The TDLS Action field |
| 3 | Dialog Token | The Dialog Token field contains a value that is |
| | | unique among TDLS Broadcast TWT Request |
| | | Action fields for which a corresponding TDLS |
| | | Broadcast TWT Response Action field has not |
| | | been received. The dialog token is specified in |
| | | 9.4.1.12 (Dialog Token field). |
| 4 | Link Identifier | The Link Identifier element is specified in |
| | | 9.4.2.61 (Link Identifier element). |
| 5 | B-TWT | The B-TWT Information element is specified in |
| | Information | 9.4.2.xx3 (B-TWT Information element). |

As shown in Table 2, the TDLS Broadcast TWT Request Action field includes a Category field, a TDLS Action field, a Dialog Token field, a Link Identifier element, and a B-TWT Information element. The Category field indicates a category of the TDLS Broadcast TWT Request Action field. The TDLS Action field differentiates the TDLS Action field formats. The Dialog Token field includes a value that is unique among TDLS Broadcast TWT Request Action fields for which a corresponding TDLS Broadcast TWT Response Action field has not been received. The Link Identifier element includes information that identifies a TDLS direct link. The B-TWT Information element is discussed in this disclosure.

In some embodiments, the TDLS Broadcast TWT Response Action field may include information shown in Table 3 below.

TABLE 3

| Order | Information | Notes |
|---|---|---|
| 1 | Category | The Category field is defined in 9.4.1.11 (Action |
| | | field) |
| 2 | TDLS Action | The TDLS Action field |
| 3 | Dialog Token | The Dialog Token field is set to a value |
| | | contained in the corresponding TDLS Broadcast |
| | | TWT Request Action field. The dialog token is |
| | | specified in 9.4.1.12 (Dialog Token field). |
| 4 | Status Code | The Status Code is specified in 9.4.1.9 (Status |
| | | Code field) |
| 5 | Link Identifier | The Link Identifier element is specified in |
| | | 9.4.2.60 (Link Identifier element). |
| 6 | B-TWT | The B-TWT Information element is specified in |
| | Information | 9.4.2.xx3 (B-TWT Information element). |

As shown in Table 3, the TDLS Broadcast TWT Response Action field includes a Category field, a TDLS Action field, a Dialog Token field, a Status Code field, a Link Identifier element, and a B-TWT Information element. The Category field indicates a category of the TDLS Broadcast TWT Response Action field. The TDLS Action field differentiates the TDLS Action field formats. The Dialog Token field is set to a value included in the corresponding TDLS Broadcast TWT Request Action field. The Status Code field indicates the success or failure of a requested operation. The Link Identifier element includes information that identifies a TDLS direct link. The B-TWT Information element is discussed in this disclosure.

In some embodiments, when a TDLS peer STA that is a member of a broadcast TWT schedule intends to transmit a frame to the other TDLS peer STA over a TDLS direct link during the TWT SP of the broadcast TWT schedule, the TDLS peer STA may send a TDLS Broadcast TWT Request frame to the other TDLS peer STA. The broadcast TWT schedule can be identified by the Broadcast TWT ID subfield in the B-TWT information element 600 in the TDLS Broadcast TWT Request frame. Upon receiving the TDLS Broadcast TWT Request frame, the other TDLS peer STA may respond by sending a TDLS Broadcast TWT Response frame with a status code of SUCCESS in the status code field. The status code of SUCCESS indicates the success of the request operation by the TDLS Broadcast TWT Request frame. Then, the other TDLS peer STA may be expected to be in an awake state during the TWT SP of the broadcast TWT schedule. In the TDLS Broadcast TWT Response frame, the value of the Broadcast TWT ID subfield in the B-TWT information element may be the same as the value of the Broadcast TWT ID subfield in the B-TWT information element within the TDLS Broadcast TWT Request frame.

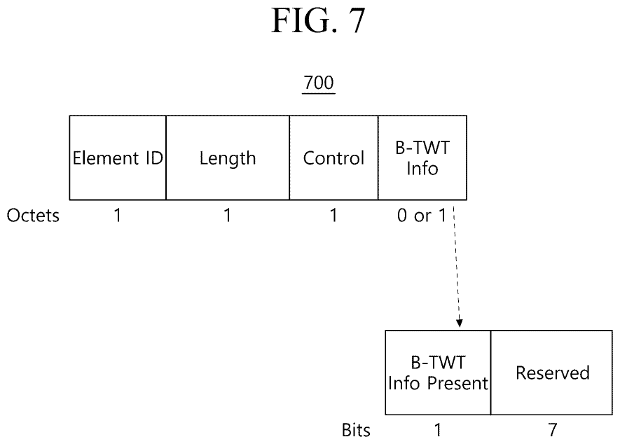

FIG. 7 shows another example format of the B-TWT information element in accordance with an embodiment. The example depicted in FIG. 7 is for illustration purposes and does not limit the scope of this disclosure to any particular implementations.

The example illustrated in FIG. 7 may be similar to the example of FIG. 6, with exceptions described below. Referring to FIG. 7, the B-TWT information element 700 includes an Element ID field, a Length field, a Control field, and a B-TWT Info field.

The Element ID field may include information to identify the B-TWT information element 700. The Length field may indicate a length of the B-TWT information element 700. The Control field may include a B-TWT Info Present subfield and Reserved bits. The B-TWT Info Present subfield may indicate the presence of the B-TWT Info field in the B-TWT information element 700. For instance, The B-TWT Info field may be present if the B-TWT Info Present subfield is set to 1. Otherwise, it may not be present. The format of the B-TWT Info field may be the same or similar to the format of the B-TWT Info field in FIG. 6. The Broadcast TWT ID subfield may include information to identify a broadcast TWT schedule advertised by an AP (e.g., AP 1 in FIGS. 5A and 5B). However, as indicated, the B-TWT Info field in FIG. 7 is optionally present.

In some embodiments, a TWT information element may include information related to cither an individual TWT agreement or a broadcast TWT schedule. The format of the TWT information element may be the same as the format of the Broadcast TWT information element.

In some embodiments, when a first STA is a member of a broadcast TWT schedule and intends to transmit frames to a second STA, which is a peer STA, over a P2P link or a TDLS direct link that the first STA set up with the second STA, the first STA may send a TDLS Broadcast TWT Request frame to the second STA requesting the second STA to stay awake during the broadcast TWT SPs. Therefore, the first STA may be able to deliver frames to the second STA during the broadcast TWT SP. If the second STA accepts the request, for example, by sending a TDLS Broadcast TWT Response frame, the second STA is expected to stay awake during the broadcast TWT SPs and anticipates receiving frames from the first STA.

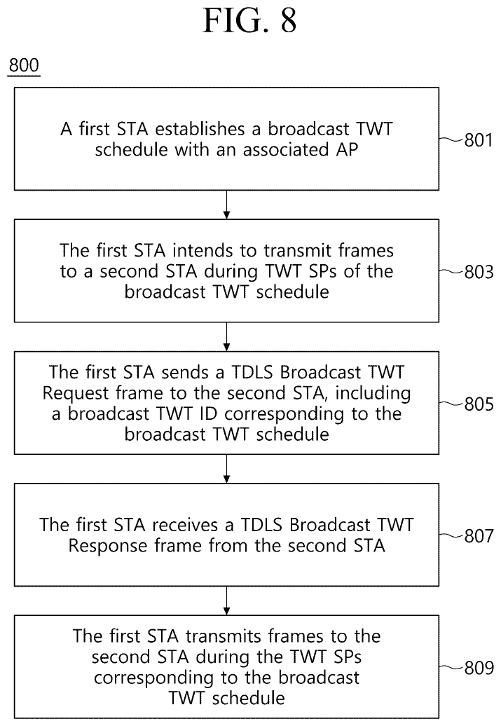

FIG. 8 shows an example process of a requester STA in accordance with an embodiment. For explanatory and illustration purposes, the example process 800 may be performed by STA 1 depicted in FIGS. 5A and 5B. Although one or more operations are described or shown in particular sequential order, in other embodiments the operations may be rearranged in a different order, which may include performance of multiple operations in at least partially overlapping time periods.

Referring to FIG. 8, the process 800 may begin in operation 801. In operation 801, a first STA establishes a broadcast TWT schedule with an AP with which the first STA is associated.

In operation 803, the first STA intends to transmit frames to a second STA during the TWT SPs corresponding to the broadcast TWT schedule. In this example, the first STA is a requester STA and the second STA is a responder STA.

In operation 805, the first STA sends a TDLS broadcast TWT request frame to the second STA. The TDLS broadcast TWT request frame requests that the second STA to stay awake during the broadcast TWT SPs. The TDLS broadcast TWT request frame includes a broadcast TWT ID corresponding to the broadcast TWT schedule.

In operation 807, the first STA receives a TDLS broadcast TWT response frame from the second STA. The TDLS broadcast TWT response frame indicates that the second STA has accepted the request by the first STA.

In operation 809, the first STA transmits frames to the second STA during the TWT SPs corresponding to the broadcast TWT schedule.

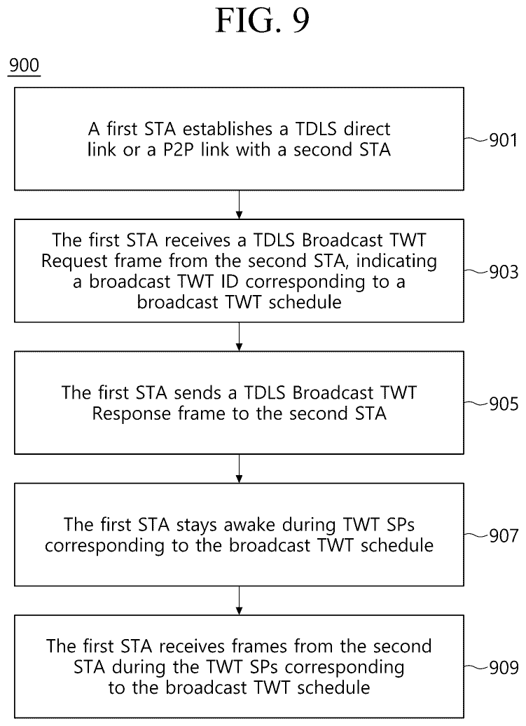

FIG. 9 shows an example process of a responder STA in accordance with an embodiment. For explanatory and illustration purposes, the example process 900 may be performed by STA 2 depicted in FIGS. 5A and 5B. Although one or more operations are described or shown in particular sequential order, in other embodiments the operations may be rearranged in a different order, which may include performance of multiple operations in at least partially overlapping time periods.

Referring to FIG. 9, the process 900 may begin in operation 901. In operation 901, a first STA establishes a TDLS direct link or a P2P link with a second STA.

In operation 903, the first STA receives a TDLS broadcast TWT request frame from the second STA. The TDLS broadcast TWT request frame indicates a broadcast TWT ID corresponding to a broadcast TWT schedule. In this example, the first STA is a responder STA and the second STA is a requester STA.

In operation 905, the first STA sends a TDLS broadcast TWT response frame to the second STA. The TDLS broadcast TWT response frame indicates that the first STA accepts the request by the second STA.

In operation 907, the first STA stays awake during the TWT SPs corresponding to the broadcast TWT schedule.

In operation 909, the first STA receives frames from the second STA during the TWT SPs corresponding to the broadcast TWT schedule.

In some embodiments, the name of the information element including the broadcast TWT schedule information may be a TWT information extension element.

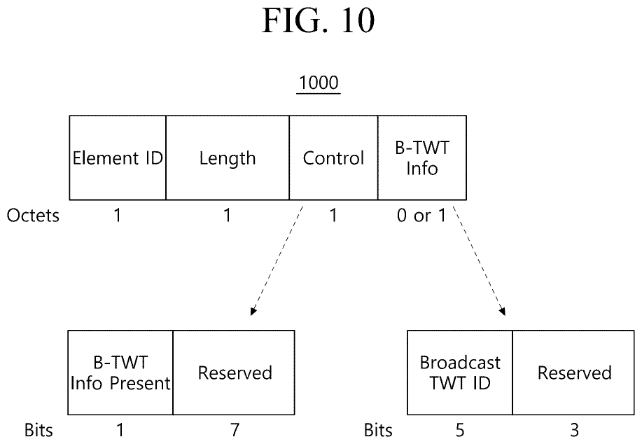

FIG. 10 shows an example format of a TWT information extension element in accordance with an embodiment. The format depicted in FIG. 10 is for illustration purposes and does not limit the scope of this disclosure to any particular implementations.

In FIG. 10, the TWT information extension element 1000 includes an Element ID field, a Length field, a Control field, and a B-TWT Info field. The Element ID field may include information to identify the TWT information extension element 1000. The Length field may indicate a length of the TWT information extension element 1000.

The Control field includes a B-TWT Info Present subfield and Reserved bits. The B-TWT Info Present Info Present subfield indicates the presence of the B-TWT Info field in the TWT information extension element 100. For instance, when the subfield is set to 1, the B-TWT Info field is present. Otherwise, the B-TWT Info field is not present.

The B-TWT Info field includes a Broadcast TWT ID subfield and Reserved bits. The Broadcast TWT ID subfield includes information to identify a broadcast TWT schedule advertised by an associated AP.

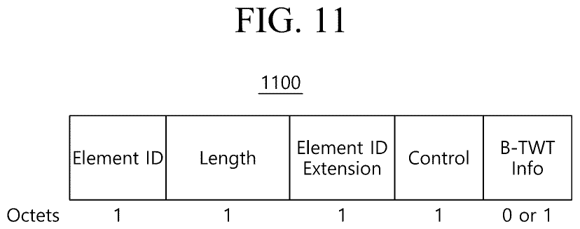

FIG. 11 shows an example format of a TWT information extension element in accordance with an embodiment. The format depicted in FIG. 11 is for illustration purposes and does not limit the scope of this disclosure to any particular implementations.

As shown in FIG. 11, the TWT information extension element 1100 includes an Element ID field, a Length field, an Element ID field, a Control field, and a B-TWT Info field. The example depicted in FIG. 11 is similar to or the same as the example of FIG. 10, with the exception of the Element ID Extension field. The Element ID field and the Element ID Extension field may include information to identify the TWT information extension element 1100.

In some embodiments, a value of the Element ID field and the Element ID Extension field may be defined as provided Table 4 below.

TABLE 4

| | Element | Element ID | | |
|---|---|---|---|---|
| Element | ID | Extension | Extensible | Fragmentable |
| . | . | . | . | . |
| . | . | . | . | . |
| . | . | . | . | . |
| TWT Information | 255 | 136 | Yes | No |
| Extension | | | | |

In some embodiments, the TDLS Broadcast TWT Request Action field may include information shown in Table 5.

TABLE 5

| Order | Information | Notes |
|---|---|---|
| 1 | Category | The Category field is defined in 9.4.1.11 (Action |
| | | field) |
| 2 | TDLS Action | The TDLS Action field |
| 3 | Dialog Token | The Dialog Token field contains a value that is |
| | | unique among TDLS Broadcast TWT Request |
| | | Action fields for which a corresponding TDLS |
| | | Broadcast TWT Response Action field has not |
| | | been received. The dialog token is specified in |
| | | 9.4.1.12 (Dialog Token field). |
| 4 | Link Identifier | The Link Identifier element is specified in |
| | | 9.4.2.60 (Link Identifier element). |
| 5 | TWT | The TWT Information Extension element is |
| | Information | specified in 9.4.2.xx3 (TWT Extension |
| | Extension | Information element). |

As shown in Table 5, the TDLS Broadcast TWT Request Action field includes a Category field, a TDLS Action field, a Dialog Token field, a Link Identifier element, and a TWT Information Extension element. The Category field indicates a category of the TDLS Broadcast TWT Request Action field. The TDLS Action field differentiates the TDLS Action field formats. The Dialog Token field includes a value that is unique among TDLS Broadcast TWT Request Action fields for which a corresponding TDLS Broadcast TWT Response Action field has not been received. The Link Identifier element includes information that identifies a TDLS direct link. The TWT Information Extension element is discussed in this disclosure.

In some embodiments, the TDLS Broadcast TWT Response Action field may include information shown in Table 6 below.

TABLE 6

| Order | Information | Notes |
|---|---|---|
| 1 | Category | The Category field is defined in 9.4.1.11 (Action |
| | | field) |
| 2 | TDLS Action | The TDLS Action field |
| 3 | Dialog Token | The Dialog Token field is set to a value contained |
| | | in the corresponding TDLS Broadcast TWT |
| | | Request Action field. The dialog token is |
| | | specified in 9.4.1.12 (Dialog Token field). |
| 4 | Status Code | The Status Code is specified in 9.4.1.9 (Status |
| | | Code field) |
| 5 | Link | The Link Identifier element is specified in |
| | Identifier | 9.4.2.60 (Link Identifier element). |
| 6 | TWT | The TWT Information Extension element is |
| | Information | specified in 9.4.2.xx3 (TWT Information |
| | Extension | Extension element). |

As shown in Table 6, the TDLS Broadcast TWT Response Action field includes a Category field, a TDLS Action field, a Dialog Token field, a Status Code field, a Link Identifier element, and a TWT Information Extension element. The Category field indicates a category of the TDLS Broadcast TWT Response Action field. The TDLS Action field differentiates the TDLS Action field formats. The Dialog Token field is set to a value included in the corresponding TDLS Broadcast TWT Request Action field. The Status Code field indicates the success or failure of a requested operation. The Link Identifier element includes information that identifies a TDLS direct link. The TWT Information Extension element is discussed in this disclosure.

In some embodiments, if a TDLS peer STA that is a member of a broadcast TWT schedule intends to transmit frames to another TDLS peer STA over a TDLS direct link during the TWT SP corresponding to the broadcast TWT schedule, then the TDLS peer STA may send a TDLS broadcast TWT request frame to the other TDLS peer STA. The broadcast TWT schedule is identified by a broadcast TWT ID subfield in a TWT information extension element in the TDLS broadcast TWT request frame. If the other TDLS peer STA, upon reception of the TDLS broadcast TWT request frame, responds by transmitting a TDLS broadcast TWT response frame with the status code SUCCESS. Then, the other TDLS peer STA is expected to be in an awake state during the TWT SPs corresponding to the broadcast TWT schedule. In the TDLS broadcast TWT response frame, the broadcast TWT ID subfield value in the TWT information extension element may be the same as the value of the broadcast TWT ID subfield in the TDLS broadcast TWT request frame.

In some embodiments, before obtaining a membership to a broadcast TWT schedule for the TDLS operation, a TWT scheduled STA needs to ensure that the TDLS peer STA is available during the TWT SPs corresponding to the broadcast TWT schedule.

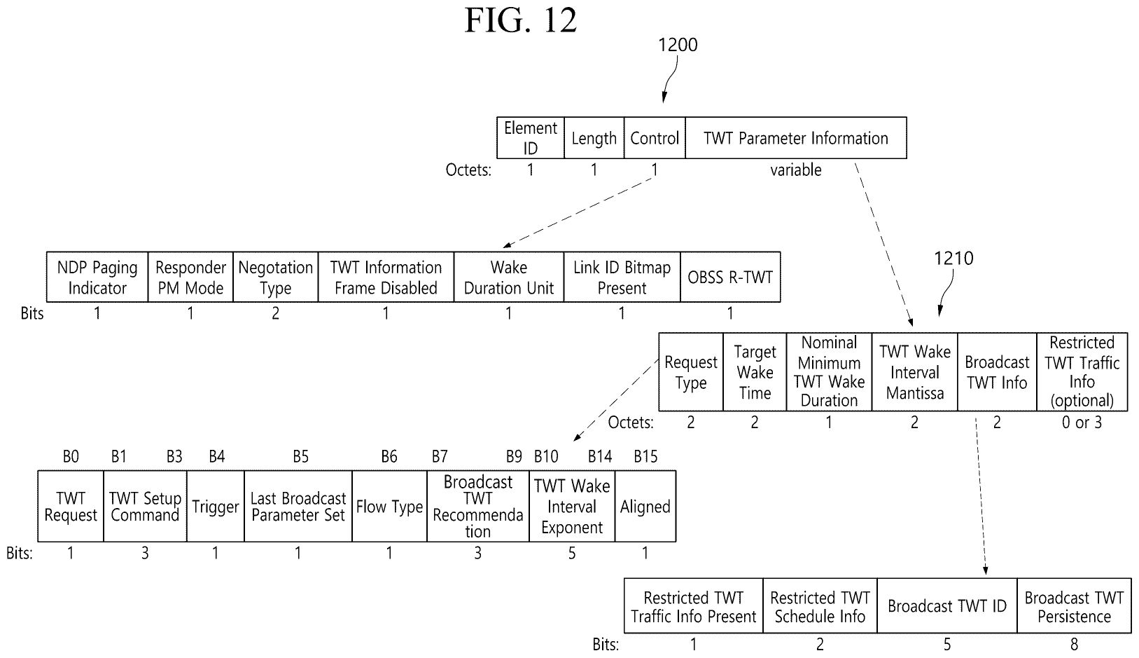

FIG. 12 shows an example format of the TWT element in accordance with an embodiment.

In FIG. 12, the TWT element 1200 may include an Element ID field, a length field, a Control field, and a TWT Parameter Information field. The Element ID field may include information to identify the TWT element 1200. The Length field may indicate a length of the TWT element 1200.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 12 illustrates the Broadcast TWT Parameter Set fields. The Broadcast TWT Parameter Set field 1210 may include a Request Type field, a Target Wake Time field, a Nominal Minimum TWT Wake Duration field, a TWT Wake Interval Mantissa field, a Broadcast TWT Info field, and an optional Restricted TWT traffic Info field.

The Request Type field of the Broadcast TWT Parameter Set field 1210 can be used to indicate the presence of the aligned TWT schedule. Referring to FIG. 12, the Request Type field includes a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Aligned subfield. The Request Type field may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first tunneled direct-link setup (TDLS) peer station (STA) in a wireless network, the first TDLS peer STA comprising:
a transceiver configured to transmit and receive signals; and
a processor operably coupled to the transceiver, the processor configured to:
transmit a TDLS broadcast TWT request frame to a second TDLS peer STA;
receive a TDLS broadcast TWT response frame from the second TDLS peer STA in response to the TDLS broadcast TWT request frame; and
transmit one or more frames to the second TDLS peer STA over a TDLS direct link during a target wake time (TWT) service period (SP) corresponding to a broadcast TWT schedule, wherein the first TDLS peer STA is a member of the broadcast TWT schedule.

2. The first TDLS peer STA of claim 1, wherein the broadcast TWT schedule is identified by a broadcast TWT identifier field in a TWT information extension element in the TDLS broadcast TWT request frame.

3. The first TDLS peer STA of claim 1, wherein the TDLS broadcast TWT response frame includes a status code of SUCCESS.

4. The first TDLS peer STA of claim 2, wherein a value in a broadcast TWT identifier field in a TWT information extension element in the TDLS broadcast TWT response frame is a same as a value in the broadcast TWT identifier field in the TWT information extension element in the TDLS broadcast TWT request frame.

5. The first TDLS peer STA of claim 1, wherein the second TDLS peer STA is expected to be in an awake state during the TWT SP corresponding to the broadcast TWT schedule.

6. The first TDLS peer STA of claim 1, wherein the TDLS broadcast TWT request frame includes a dialog token field that includes a value that is unique among TDLS broadcast TWT request Action fields for which a corresponding TDLS broadcast TWT response action field has not been received.

7. The first TDLS peer STA of claim 1, wherein the TDLS broadcast TWT response frame includes a dialog token field that is set to a value included in a corresponding TDLS broadcast TWT request action field.

8. A first tunneled direct-link setup (TDLS) peer station (STA) in a wireless network, the first TDLS peer STA comprising:
a transceiver configured to transmit and receive signals; and
a processor operably coupled to the transceiver, the processor configured to:
receive a TDLS broadcast TWT request frame from a second TDLS peer STA;
transmit a TDLS broadcast TWT response to the second TDLS peer STA in response to the TDLS broadcast TWT request frame; and
receive one or more frames from the second TDLS peer STA over a TDLS direct link during a target wake time (TWT) service period (SP) corresponding to a broadcast TWT schedule, wherein the second TDLS peer STA is a member of the broadcast TWT schedule.

9. The first TDLS peer STA of claim 8, wherein the broadcast TWT schedule is identified by a broadcast TWT identifier field in a TWT information extension element in the TDLS broadcast TWT request frame.

10. The first TDLS peer STA of claim 8, wherein the TDLS broadcast TWT response frame includes a status code of SUCCESS.

11. The first TDLS peer STA of claim 9, wherein a value in a broadcast TWT identifier field in a TWT information extension element in the TDLS broadcast TWT response frame is a same as a value in the broadcast TWT identifier field in the TWT information extension element in the TDLS broadcast TWT request frame.

12. The first TDLS peer STA of claim 8, wherein the first TDLS peer STA is expected to be in an awake state during the TWT SP corresponding to the broadcast TWT schedule.

13. The first TDLS peer STA of claim 8, wherein the TDLS broadcast TWT request frame includes a dialog token field that includes a value that is unique among TDLS broadcast TWT request Action fields for which a corresponding TDLS broadcast TWT response action field has not been received by the second TDLS peer STA.

14. The first TDLS peer STA of claim 8, wherein the TDLS broadcast TWT response frame includes a dialog token field that is set to a value included in a corresponding TDLS broadcast TWT request action field.

15. A method operated by a first tunneled direct-link setup (TDLS) peer station (STA) in a wireless network, the method comprising:
transmitting a TDLS broadcast TWT request frame to a second TDLS peer STA;
receiving a TDLS broadcast TWT response frame in response to the TDLS broadcast TWT request frame; and
transmitting one or more frames to the second TDLS peer STA over a TDLS direct link during a target wake time (TWT) service period (SP) corresponding to a broadcast TWT schedule, wherein the first TDLS peer STA is a member of the broadcast TWT schedule.

16. The method of claim 15, wherein the broadcast TWT schedule is identified by a broadcast TWT identifier field in a TWT information extension element in the TDLS broadcast TWT request frame.

17. The method of claim 15, wherein the TDLS broadcast TWT response frame includes a status code of SUCCESS.

18. The method of claim 16, wherein a value in a broadcast TWT identifier field in a TWT information extension element in the TDLS broadcast TWT response frame is a same as a value in the broadcast TWT identifier field in the TWT information extension element in the TDLS broadcast TWT request frame.

19. The method of claim 15, wherein the second TDLS peer STA is expected to be in an awake state during the TWT SP corresponding to the broadcast TWT schedule.

20. The method of claim 15, wherein:
the TDLS broadcast TWT request frame includes a dialog token field that includes a value that is unique among TDLS broadcast TWT request Action fields for which a corresponding TDLS broadcast TWT response action field has not been received; and
the TDLS broadcast TWT response frame includes a dialog token field that is set to a value included in a corresponding TDLS broadcast TWT request action field.
